(19) United States
(12) Patent Application Publication
(10) Pub. No.: US 2024/0401170 A1
(43) Pub. Date: Dec. 5, 2024

(54) RECOVERING MULTIPLE ELEMENTS FROM AQUEOUS STREAMS

(71) Applicant: ExxonMobil Technology and Engineering Company, Spring, TX (US)

(72) Inventors: William P. MEURER, Magnolia, TX (US); Jay A. BARR, Spring, TX (US); Nathan P. FRANKA, The Woodlands, TX (US); Robert E. GRAHAM, Houston, TX (US); Mohan KALYANARAMAN, Media, PA (US); Deepak A. MUSALE, Conroe, TX (US)

(21) Appl. No.: 18/667,171

(22) Filed: May 17, 2024

Related U.S. Application Data
(60) Provisional application No. 63/505,547, filed on Jun. 1, 2023.

(51) Int. Cl. C22B 60/00; B01D 61/02; C22B 3/22; C22B 3/24; C22B 26/12

(52) U.S. Cl. CPC C22B 60/00; B01D 61/027; C22B 3/22; C22B 3/24; C22B 26/12

(57) ABSTRACT

A system and method of extracting elements from an aqueous stream are described herein. The method includes designing a process to extract at least two elements from the aqueous product stream. The at least two elements have different commercial values. The process is optimized to minimize a cost of extracting the at least two elements and to maximize a value of extracting the at least two elements. The method further includes extracting the at least two elements according to the process.

### CROSS-REFERENCE TO RELATED APPLICATION

This application claims priority to and the benefit of U.S. Provisional Application No. 63/505,547, entitled “RECOVERING MULTIPLE ELEMENTS FROM AQUEOUS STREAMS,” having a filing date of Jun. 1, 2023, the disclosure of which is incorporated herein by reference in its entirety.

### FIELD OF THE DISCLOSURE

The present disclosure relates generally to methods of recovering elements and compounds from aqueous streams. In particular, the methods set forth herein relate to recovering multiple elements or compounds from an aqueous stream, while optimizing cost of recovery and value of recovered materials.

### BACKGROUND OF THE DISCLOSURE

Aqueous streams of liquid including aqueous solutions are frequently a byproduct of industrial operations such as hydrocarbon production. During hydrocarbon production, water with variable amounts of dissolved solids present in the hydrocarbon reservoir is pulled in the producing well and flows from the wellhead with the hydrocarbons. Other aqueous streams can be related to industrial processes such as: mineral processing that require water to help dissolve impurities, ground water that flows into mine works and has to pumped out to minimize flooding, and aqueous solution streams that pumped into the ground to preferentially dissolve or leach out certain elements or compounds and then produced at the surface. Elements or compounds may be present in an aqueous stream and it may be desirable to remove them from the aqueous stream. Moreover, the elements or compounds that exist in aqueous streams may have value, making their recovery profitable. Examples of elements that could have potential value are lithium (Li), bromine (Br), and boron (B). Other elements such as radium (Ra) have historically been considered as waste products to be disposed of, not recovered.

Various methods of separating constituents present in an aqueous stream are known. One example is filtration (including nanofiltration), in which an aqueous stream is passed through a filter or membrane. The residuals from filtration include a retentate, which is retained in the filter or membrane, and a permeate, which is a substance that is passed through the filter or membrane. This may be followed by preferential extraction techniques to separate the preferred element from elements of similar ionic configuration.

Another technique of separating elements in an aqueous solution is liquid-liquid extraction. This process separates a solute from a solution by mixing with another liquid solvent. The solvent is added to the solution to extract the solute, which is then removed from the solvent.

Other techniques of recovering elements or compounds include selective adsorption and crystallization. In selective adsorption, one or more compounds of a mixture are adsorbed into a solid material. Resin or activated carbon may be used as the solid material. Other components of the mixture pass through the solid and are unaffected. The adsorbed components may be recovered from the solid by a process of elution with an appropriate solvent.

In crystallization, a solid material such as a pure compound, solid solution, or mixture of compounds is precipitated from a solution by cooling or evaporation. Material is recovered in the form of crystals when the solubility of the material in the mixture is reduced. The crystals may be separated from the remaining solution using filtration or centrifugation. Crystallization may be used for purification of chemicals such as pharmaceuticals.

Still another example of a technique that may be employed to remove elements or compounds from an aqueous solution is cation exchange. Cation exchange may be used to separate and purify alkaline earth metals, including calcium and magnesium, from their respective salts. In cation exchange, metal ions in a solution bind to functional groups in a stationary phase such as a resin. In this manner, other cations that were previously bound to the resin are displaced. The displaced cations, such as sodium or hydrogen, may be released into the solution, creating an ionic exchange. The bound metal ions may be eluted from the resin using an acid or salt solution to create a purified solution of alkaline earth metal ions. When elements or compounds are present as oxyanions in aqueous system, anion exchange process may be used. Anion exchange is used, for example, for removing arsenate, selenate, and/or chromate, which are oxyanions of cations such as arsenic, selenium, chromium, respectively.

Current approaches to element recovery from aqueous streams such as produced water are focused on delivering high concentration of a single element at minimal cost. Moreover, recovery decisions are made based on identifying the most profitable or otherwise beneficial method for the single highest value element (a function of the concentration and value of the element). An improved method of evaluating recovery of elements or compounds from aqueous streams is desired.

### SUMMARY OF THE DISCLOSURE

An embodiment described herein provides a method of recovering elements from an aqueous stream. The method includes designing a process to recover at least two elements from the aqueous product stream. The at least two elements have different commercial values. The process is optimized to minimize a cost of recovering the at least two elements and to maximize a value of recovering the at least two elements. The method also includes recovering the at least two elements according to the process.

Another embodiment described herein provides a method of recovering radium and lithium from an aqueous stream. The method includes filtering the aqueous stream to produce a permeate containing lithium and a retentate containing radium. The method also includes processing the permeate to recover the lithium. The method further includes processing the retentate to recover the radium.

Still another embodiment described herein provides a computer-implemented method of designing a process to recover elements from an aqueous stream. The computer-implemented method includes designing a process to recover at least two elements from the aqueous product stream. The at least two elements have different commercial values. The method further includes optimizing the process to minimize a cost of recovering the at least two elements and to maximize a value of recovering the at least two elements.

A still further embodiment described herein provides a non-transitory, computer-readable storage medium that includes program instructions. The program instructions are executable by a processor to cause the processor to design a process to recover at least two elements from the aqueous product stream. The at least two elements have different commercial values. The program instructions also cause the processor to optimize the process to minimize a cost of recovering the at least two elements and to maximize a value of recovering the at least two elements.

### BRIEF DESCRIPTION OF THE DRAWINGS

FIG. 1 is a flowchart depicting an exemplary method of extracting multiple elements or compounds from aqueous stream, according to the present techniques;

FIG. 2 is a flowchart showing an example of a process of extracting lithium and radium from an aqueous stream, according to the present techniques;

FIG. 3 is a block diagram of an exemplary cluster computing system that may be utilized to implement at least a portion of the present techniques; and

FIG. 4 is a block diagram of an exemplary non-transitory, computer-readable storage medium that may be used for the storage of data and modules of program instructions for implementing at least a portion of the present techniques.

It should be noted that the figures are merely examples of the present techniques, and no limitations on the scope of the present techniques are intended thereby. Further, the figures are generally not drawn to scale, but are drafted for purposes of convenience and clarity in illustrating various aspects of the techniques.

### DETAILED DESCRIPTION

In the following detailed description section, the specific examples of the present techniques are described in connection with preferred embodiments. However, to the extent that the following description is specific to a particular embodiment or a particular use of the present techniques, this is intended to be for example purposes only and simply provides a description of the embodiments. Accordingly, the techniques are not limited to the specific embodiments described below, but rather, include all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the terms “a” and “an” mean one or more when applied to any embodiment described herein. The use of “a” and “an” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

The term “aqueous solution” means a solution in which a solute is dissolved in a solvent that is mainly water. Solutes dissolved in water may be a solid, liquid, or gas in their pure form at the pressure and temperature conditions of the solution. The solute can be any substance that is soluble in water, meaning it can dissolve in water to form a homogeneous mixture. As used herein, the term “aqueous solution” is broad enough to encompass small water-soluble solvents such as alcohols or hydrocarbons. The term “aqueous stream” means a flow of water-based liquid that may contain dissolved or suspended substances, such as anions, cations, inorganic compounds, organic compounds, or microbes.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently.

The present techniques relate to a system and method for optimizing recovery of two or more elements (metals, metalloids, and nonmetals) from an aqueous solution. The solution could be water/brine produced from, but not limited to natural aquifer systems, hydrocarbon production, hydrothermal production, in situ mining, and mine drainage. One goal of the system is to define an optimized extraction process stream for recovering multiple elements from the same aqueous solution.

One aspect of the present techniques is the recognition that recovery of multiple elements from aqueous streams may require use of extraction techniques that are suboptimal to one or more of the elements being recovered. The suboptimal extraction can provide greater overall value either by allowing more cost-effective extraction of other elements and/or higher recovery efficiencies of other elements. Another aspect of the present techniques relates to an optimization of the sequence of processing and removal steps to minimize cost and/or assure the highest recovery efficiencies. Still another aspect of the present techniques is the recognition that some elements that are viewed as either of little value/use or, as in the case of radium, negative value because of radioactivity/toxicity are actually of value but their usage is either not developed or is undeveloped because of a lack of production.

Although it is recognized that many water sources have more than one element of economic value, there are currently no aqueous recovery operations that target more than one element. Often, pursuit of recovery of a single element can negatively impact the recovery of other elements. A consequence of this targeted single-element approach is that the recovery techniques can limit or destroy the value of recovery of other elements. However, there are multiple different recovery strategies that can be used to recover any given element. The present techniques are directed to systems and methods that develop an optimized process to recover multiple elements or compounds from an aqueous stream.

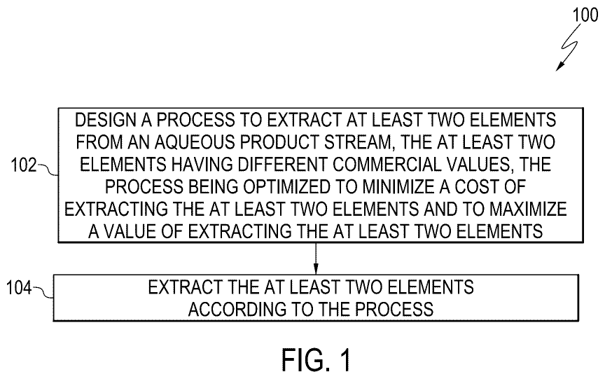

FIG. 1 is a flowchart depicting an exemplary method 100 of extracting multiple elements or compounds from aqueous stream, according to the present techniques. The method 100 begins at block 102 with the designing of a process to extract at least two elements from the aqueous product stream. The two elements have different commercial values, such that extraction of one of the elements is of less value than the other element.

The extraction process is optimized to minimize a cost of extracting the at least two elements and/or to maximize a value of extracting the at least two elements. In this manner, the combined value of the recovered elements may be greater than the value of either element individually.

Examples of minimizing cost may include using a renewable energy source to power at least a part of the process or recovering elements. The renewable energy source may include solar power, wind power or capturing excess heat from a process operation.

Maximizing the value of extracting the elements in the context of the present techniques may include maximizing profit or, alternatively, a non-monetary benefit. An example of a non-monetary benefit includes the reduction of greenhouse gas emissions.

In an exemplary embodiment, extraction of one element by itself from an aqueous stream may not be economically viable or may even be considered undesirable. Further, extraction of a single element may not result in production of optimal value from an aqueous stream. For example, it might not be economically feasible or desirable to extract a radioactive element such as radium from an aqueous stream. Radium has historically been considered a waste product and aqueous streams comprising radium have been considered a liability to be disposed of rather than exploited. According to the present techniques, however, extraction of a more valuable element from an aqueous stream in conjunction with the extraction of radium to be used for a productive purpose rather than being disposed of may result in enhanced value of a recovery operation. Conversely, extraction of radium may give rise to economical extraction or recovery of an element, the recovery of which might be cost prohibitive absent the capital investment to recover the radium.

Moreover, a process may be created in which the recovery of a first element (e.g., lithium) may provide the impetus for performing a recovery operation that may yield enhanced value by employing additional process steps to recover a second element (e.g., radium), as well. For example, radium-226 could be extracted and further processed to provide a useful compound such as actinium-225, which is useful in performing certain cancer treatments. Thus, the recovery of multiple elements could provide additional value when compared to recovering only one element or discarding an aqueous stream as a waste product. Various methods of recovering radium-226 and processing it into actinium-225 are described in U.S. patent application Ser. No. 18/056,415, filed on Nov. 17, 2022, entitled “Methods of Using and Converting Recovered Radium,” the contents of which are hereby incorporated by reference as if set forth in their entirety herein.

At block 104 of the method 100, the process created as described with respect to block 102 is executed. Moreover, the process is used to recover at least two elements from the aqueous stream.

As noted above, the present techniques may be employed to create a process for optimizing value (maximizing) and cost (minimizing) of recovering both lithium and radium from a single aqueous stream. Examples of processes that may be used to recover lithium include the recovery of lithium by evaporative concentration of the Li-source stream followed by direct crystallization of LiOH or Li2CO3. An alternative method of recovering lithium is direct extraction of lithium from the source stream using ion-exchange.

Examples of methods of recovering radium include inducing separation of radium from the source stream via its inclusion in crystallizing solids (typically barite), filtration of solids, and extraction of the radium from the solids. Alternatively, radium may be recovered by preventing the radium from crystallizing while filtering, separating monovalent cations, and then extracting radium from solution from other divalent cations. A source stream that includes enough lithium and radium for extraction requires an optimization be done to determine the optimal processing stream. The present techniques may be employed to design a process that includes aspects of lithium recovery and radium recovery.

In a first example, evaporative concentration may be used to extract radium. The radium could be collected along with other precipitates governed by the chemistry of the water. Lithium could then be removed via direct crystallization. In this example, however, the volume and type of solids that precipitate with the radium could potentially make separation problematic.

In a second example, lithium is extracted via ion-exchange using an exchange resin that strongly prefers Li under the operating conditions (aqueous steam composition, pressure, temperature, pH, etc.). The source aqueous stream may then be passed to either radium extraction process referred to above. In the second example, however, any radium that goes into precipitates formed very early would be lost to primary filtration prior to the exchange resin.

In a third example, radium is precipitated from an aqueous stream and filtered out for processing. The remaining water stream may be sent to either lithium extraction technique referred to above. The third example, however, may require additional modifications of the water chemistry (pH adjustment, etc.) prior to going to the exchange resin. The loss of cations would need to be accounted for in the evaporation process as it will shift saturation points and may cause undesirable precipitates to form.

In a fourth example, the aqueous stream may be split optimized for radium extraction and the monovalent stream may be directed to evaporation or direct liquid extraction for Li recovery. In the fourth example, the monovalent cation stream may have too low of a total dissolved load for optimal direct Li extraction via an exchange resin, and the evaporation approach will need to be refined anew for any different stream complicating clean crystallization of lithium phases resulting in a higher fraction of impurities and lower total Li recovery.

Optimization of extraction strategies according to the present techniques both minimize a cost function for extraction including both capital and operating cost while also maximizing a value function that accounts for the extraction of two or more elements, their corresponding initial concentrations, and expected market value. These two functions may be combined to form an objective function that allows a maximization of profit that can be used to assess potential processing strategies in multi-parameter space. Note that non-monetary consideration (e.g., greenhouse gas (GHG) emissions) could be included in this optimization by adding a weighting function or an additional cost/value stream.

The present techniques may be employed to optimize extraction strategies to permit recovery of two or more elements, including radioactive elements. Moreover, optimization includes designing a process to obtain sufficient quantities of recovered elements while maximizing the energy efficiency, reducing number and volume of residual streams for disposal, and deploying lower capital.

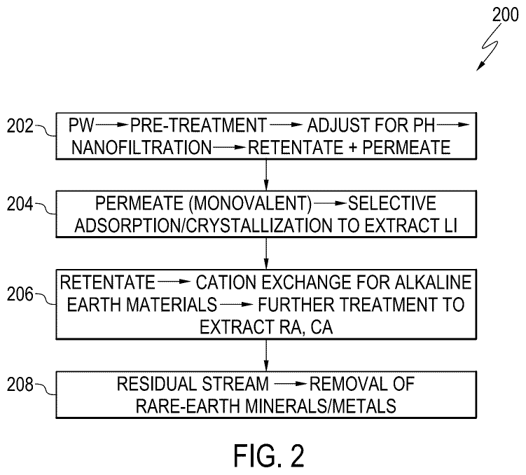

FIG. 2 is a flowchart showing an example of a process 200 of extracting lithium and radium from an aqueous stream, according to the present techniques. As explained herein, the process 200 has been optimized to reduce cost and increase value of multiple recovered materials.

The process 200 begins with a first step 202. The purpose of the first step is to perform an initial separation of an aqueous steam into different portions to facilitate the recovery of different elements. In the case of the process 200, one of the portions will be used to recover radium and the other portion will be used to recover lithium. The first step 202 begins with the production of an aqueous stream of produced water (PW). Next, the aqueous stream PW may be subjected to one or more pre-treatment steps. Examples of pre-treatment steps may include filtration to remove suspended solids, removal of oil and grease, H2S, iron, calcium, magnesium by known methods. The aqueous stream PW may then be adjusted for pH, which may improve the productivity of the process 200. Exchange resins are most effective within a narrow range of pH. Liquid-liquid extraction requires a narrow range of pH of the PW stream to allow effective transfer of the desired elements.

The first step 202 continues by applying nanofiltration to the aqueous stream PW. The result of the nanofiltration is a permeate, which will be used to recover lithium, and a retentate, which will be used to recover radium. Examples of the use of nanofiltration for concentration of a radium stream are set forth in U.S. patent application Ser. No. 18/056,415, incorporated by reference hereinbefore. Nanofiltration concentration is performed by passing water and more monovalent cations and anions in the permeate and retaining more bivalent ions in the retentate.

The process 200 continues at a second step 204. The second step 204 involves further processing of the permeate resulting from nanofiltration to recover lithium. In the second step 204, the monovalent permeate may be subjected to selective adsorption or crystallization in order to extract lithium.

The process 200 next includes a third step 206. The third step 206 involves further processing of the retentate resulting from nanofiltration to recover other elements such as radium or calcium (or both). In the third step 206, cation exchange may be performed on the retentate to produce alkaline earth materials. Examples of alkaline earth materials that may be produced in this manner include Ba, Mg, Ra, and Sr. Further treatment including sequential or fractional precipitation or crystallization based on differences in solubility products of elements in the retentate may be performed to extract radium or calcium.

The process 200 proceeds to a fourth step 208. The fourth step 208 involves processing of a residual stream of the aqueous stream PW after processing through the first step 202, the second step 204 and the third step 206. In a fourth and optional step 208, the residual stream is processed to remove rare-earth minerals and/or metals. In this manner, further valuable byproducts of the process 200 may be obtained.

It should be noted that process optimization may include recovery of elements at varying degrees of purity. Moreover, different applications of the recovered elements could require different levels of purity. By way of example, extraction of lithium according to the present techniques may be performed to obtain lithium having purity of greater than 95%, greater than 96%, greater than 97%, greater than 98%, greater than 99%, greater than 99.1%, greater than 99.2%, greater than 99.3%, greater than 99.4%, greater than 99.5%, greater than 99.6%, greater than 99.7%, greater than 99.8%, greater than 99.9% and/or greater than 99.95%.

The present technological innovation contemplates the use of machine learning to design processes of recovering multiple elements from an aqueous stream. For example, the designing of the process according to the present techniques may be performed by a machine learning method. The machine learning method may include performing machine learning on a set of processes optimized for recovery of a single element.

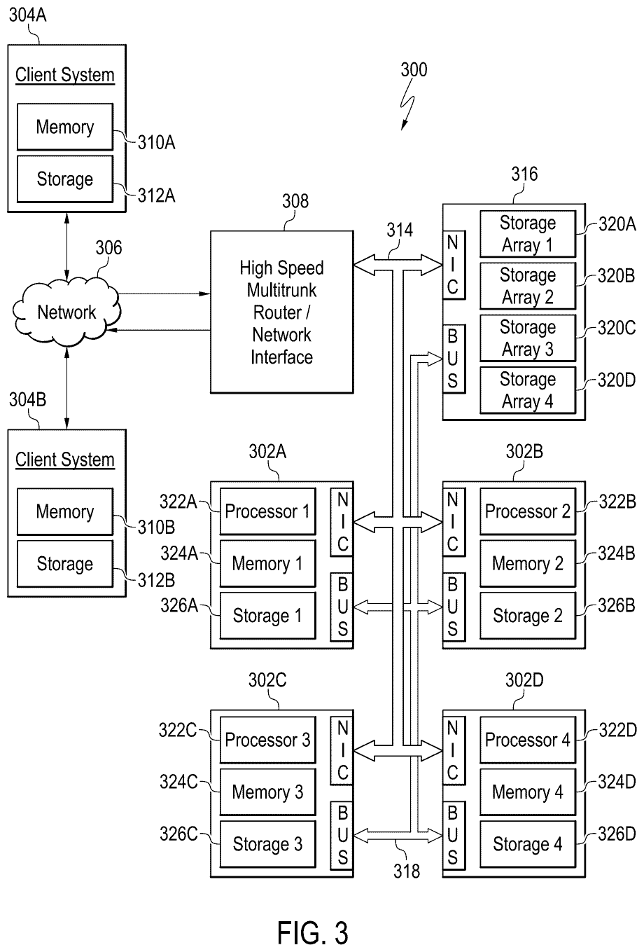

FIG. 3 is a block diagram of an exemplary cluster computing system 300 that may be utilized to implement at least a portion of the present techniques. The exemplary cluster computing system 300 shown in FIG. 3 has four computing units 302A, 302B, 302C, and 302D, each of which may perform calculations for a portion of the present techniques. However, one of ordinary skill in the art will recognize that the cluster computing system 300 is not limited to this configuration, as any number of computing configurations may be selected. For example, a smaller analysis may be run on a single computing unit, such as a workstation, while a large calculation may be run on a cluster computing system 300 having tens, hundreds, or even more computing units.

The cluster computing system 300 may be accessed from any number of client systems 304A and 304B over a network 306, for example, through a high-speed network interface 308. The network 306 may include a cloud computing environment. The computing units 302A to 302D may also function as client systems, providing both local computing support and access to the wider cluster computing system 300.

The network 306 may include a local area network (LAN), a wide area network (WAN), the Internet, or any combinations thereof. Each client system 304A and 304B may include one or more non-transitory, computer-readable storage media for storing the operating code and program instructions that are used to implement at least a portion of the present techniques, as described further with respect to the non-transitory, computer-readable storage media of FIG. 3. For example, each client system 304A and 304B may include a memory device 310A and 310B, which may include random access memory (RAM), read only memory (ROM), and the like. Each client system 304A and 304B may also include a storage device 312A and 312B, which may include any number of hard drives, optical drives, flash drives, or the like.

The high-speed network interface 308 may be coupled to one or more buses in the cluster computing system 300, such as a communications bus 314. The communication bus 314 may be used to communicate instructions and data from the high-speed network interface 308 to a cluster storage system 316 and to each of the computing units 302A to 302D in the cluster computing system 300. The communications bus 314 may also be used for communications among the computing units 302A to 302D and the cluster storage system 316. In addition to the communications bus 314, a high-speed bus 318 can be present to increase the communications rate between the computing units 302A to 302D and/or the cluster storage system 316.

In some embodiments, the one or more non-transitory, computer-readable storage media of the cluster storage system 316 include storage arrays 320A, 320B, 320C and 320D for the storage of models, data, visual representations, results (such as graphs, charts, and the like used to convey results obtained using the present techniques), code, and other information concerning the implementation of at least a portion of the present techniques. The storage arrays 320A to 320D may include any combinations of hard drives, optical drives, flash drives, or the like.

Each computing unit 302A to 302D includes at least one processor 322A, 322B, 322C and 322D and associated local non-transitory, computer-readable storage media, such as a memory device 324A, 324B, 324C and 324D and a storage device 326A, 326B, 326C and 326D, for example. Each processor 322A to 322D may be a multiple core unit, such as a multiple core central processing unit (CPU) or a graphics processing unit (GPU). Each memory device 324A to 324D may include ROM and/or RAM used to store program instructions for directing the corresponding processor 322A to 322D to implement at least a portion of the present techniques. Each storage device 326A to 326D may include one or more hard drives, optical drives, flash drives, or the like. In addition, each storage device 326A to 326D may be used to provide storage for models, intermediate results, data, images, or code used to implement at least a portion of the present techniques.

The present techniques are not limited to the architecture or unit configuration illustrated in FIG. 3. For example, any suitable processor-based device may be utilized for implementing at least a portion of the embodiments described herein, including (without limitation) personal computers, laptop computers, computer workstations, mobile devices, and multi-processor servers or workstations with (or without) shared memory. Moreover, the embodiments described herein may be implemented, at least in part, on application specific integrated circuits (ASICs) or very-large-scale integrated (VLSI) circuits. In fact, those skilled in the art may utilize any number of suitable structures capable of executing logical operations according to the embodiments described herein.

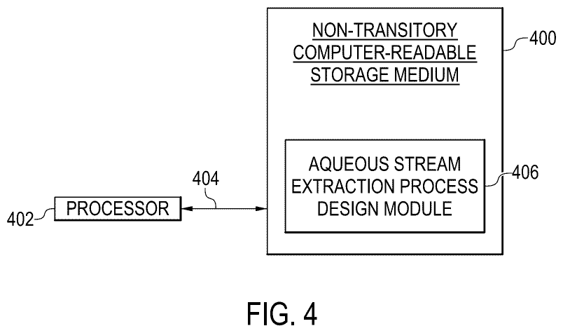

FIG. 4 is a block diagram of an exemplary non-transitory, computer-readable storage medium 400 that may be used for the storage of data and modules of program instructions for implementing at least a portion of the present techniques. The non-transitory, computer-readable storage medium 400 may include a memory device, a hard disk, and/or any number of other devices, as described herein. A processor 402 may access the non-transitory, computer-readable storage medium 400 over a bus or network 404. While the non-transitory, computer-readable storage medium 400 may include any number of modules for implementing the present techniques, in some embodiments, the non-transitory, computer-readable storage medium 400 includes an aqueous stream extraction process design module 406 for performing the techniques described herein (and/or any suitable variations thereof). Moreover, the aqueous stream extraction process design module 406 may be adapted to analyze data representing the design of the processes 100 or 200 for extracting multiple elements from an aqueous stream according to the present techniques.

In one or more embodiments, the present techniques may be susceptible to various modifications and alternative forms, such as the following embodiments as noted in paragraphs 1 to 33:
1. A method of recovering elements from an aqueous stream, the method comprising: designing a process to recover at least two elements from the aqueous product stream, the at least two elements having different commercial values, the process being optimized to minimize a cost of recovering the at least two elements and to maximize a value of recovering the at least two elements; and recovering the at least two elements according to the process.
2. The method of recovering elements recited in paragraph 1, wherein at least one of the at least two elements comprises a component of a compound.
3. The method of recovering elements recited in paragraph 2, wherein the compound comprises an inorganic compound.
4. The method of recovering elements recited in any of paragraphs 1 to 3, wherein the process comprises a step of filtration, and wherein at least one of the at least two elements resides as a portion of a retentate of the filtration.
5. The method of recovering elements recited in any of paragraphs 1 to 4, wherein the process comprises a step of filtration, and wherein at least one of the at least two elements resides as a portion of a permeate of the filtration.
6. The method of recovering elements recited in any of paragraphs 1 to 5, wherein one of the at least two elements comprises radium.
7. The method of recovering elements recited in paragraph 6, wherein the radium is converted to actinium.
8. The method of recovering elements recited in paragraph 6, wherein the radium comprises radium-226, the radium-226 being processed to produce actinium-225.
9. The method of recited in any of paragraphs 1 to 8, wherein one of the at least two elements comprises lithium.
10. The method of recovering elements recited in any of paragraphs 1 to 9, wherein maximizing the value comprises maximizing value of a yield of the at least two elements combined.
11. The method of recovering elements recited in any of paragraphs 1 to 10, wherein minimizing the cost of recovering the at least two elements comprises minimizing capital investment needed to recover the at least two elements.
12. The method of recovering elements recited in any of paragraphs 1 to 11, wherein minimizing the cost of recovering the at least two elements comprises using a renewable energy source.
13. The method of recovering elements recited in paragraph 12, wherein the renewable energy source comprises solar power, wind power or capturing excess heat from a process operation.
14. The method of recovering elements recited in any of paragraphs 1 to 13, wherein maximizing the value includes maximizing a non-monetary benefit.
15. The method of recovering elements recited in paragraph 14, wherein the non-monetary benefit comprises reducing emission of greenhouse gasses.
16. The method of recovering elements recited in any of paragraphs 1 to 15, wherein the designing of the process is performed by a machine learning method, the machine learning method comprising performing machine learning on a set of processes optimized for recovery of a single element.
17. A method of recovering radium and lithium from an aqueous stream, the method comprising: filtering the aqueous stream to produce a permeate containing lithium and a retentate containing radium; processing the permeate to recover the lithium; and processing the retentate to recover the radium.
18. The method of recovering radium and lithium recited in paragraph 17, wherein the method is optimized to minimize a cost of recovering the radium and lithium and to maximize a value of recovering the radium and the lithium.
19. The method of recovering radium and lithium recited in paragraph 18, wherein maximizing the value comprises maximizing value of a yield of the radium and lithium combined.
20. The method of recovering radium and lithium recited in paragraphs 18 or 19, wherein maximizing the value includes maximizing a non-monetary benefit.
21. The method of recovering radium and lithium recited in paragraph 20, wherein the non-monetary benefit comprises reducing emission of greenhouse gasses.
22. The method of recovering radium and lithium recited in any of paragraphs 18 to 21, wherein minimizing the cost of recovering the radium and the lithium comprises minimizing capital investment needed to recover the radium and the lithium.
23. The method of recovering radium and lithium recited in paragraphs 18 to 22, wherein minimizing the cost of recovering the radium and the lithium comprises using a renewable energy source.
24. The method of recovering radium and lithium recited in paragraph 23, wherein the renewable energy source comprises solar power, wind power or capturing excess heat from a process operation.
25. The method of recovering radium and lithium recited in any of paragraphs 17 to 24, wherein filtering the aqueous stream comprises nanofiltration.
26. The method of recovering radium and lithium recited in any of paragraphs 17 to 25, wherein processing the permeate to recover the lithium comprises performing selective adsorption.
27. The method of recovering radium and lithium recited in any of paragraphs 17 to 26, wherein processing the permeate to recover the lithium comprises performing crystallization.
28. The method of recovering radium and lithium recited in any of paragraphs 17 to 27, wherein processing the retentate to recover the radium comprises performing selective adsorption.
29. The method of recovering radium and lithium recited in any of paragraphs 17 to 28, wherein the radium comprises radium-226, the radium-226 being processed to produce actinium-225.
30. The method of recovering radium and lithium recited in any of paragraphs 17 to 29, wherein the radium is processed to produce actinium.
31. The method of recovering radium and lithium recited in any of paragraphs 17 to 30, comprising adjusting a pH level of the aqueous stream prior to recovering the radium and the lithium.
32. A computer-implemented method of designing a process to recover elements from an aqueous stream, the computer-implemented method comprising: designing a process to recover at least two elements from the aqueous product stream, the at least two elements having different commercial values; and optimizing the process to minimize a cost of recovering the at least two elements and to maximize a value of recovering the at least two elements.
33. A non-transitory, computer-readable storage medium comprising program instructions that are executable by a processor to cause the processor to: design a process to recover at least two elements from the aqueous product stream, the at least two elements having different commercial values; and optimize the process to minimize a cost of recovering the at least two elements and to maximize a value of recovering the at least two elements.

### INDUSTRIAL APPLICABILITY

The systems and methods disclosed herein are applicable to natural resource extraction industries and recovery of valuable elements and compounds related thereto.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of recovering elements from an aqueous stream, the method comprising:
designing a process to recover at least two elements from the aqueous product stream, the at least two elements having different commercial values, the process being optimized to minimize a cost of recovering the at least two elements and to maximize a value of recovering the at least two elements; and
recovering the at least two elements according to the process.

2. The method of recovering elements recited in claim 1, wherein at least one of the at least two elements comprises a component of a compound.

3. The method of recovering elements recited in claim 2, wherein the compound comprises an inorganic compound.

4. The method of recovering elements recited in claim 1, wherein the process comprises a step of filtration, and wherein at least one of the at least two elements resides as a portion of a retentate of the filtration.

5. The method of recovering elements recited in claim 1, wherein the process comprises a step of filtration, and wherein at least one of the at least two elements resides as a portion of a permeate of the filtration.

6. The method of recovering elements recited in claim 1, wherein one of the at least two elements comprises radium.

7. The method of recovering elements recited in claim 6, wherein the radium is converted to actinium.

8. The method of recovering elements recited in claim 6, wherein the radium comprises radium-226, the radium-226 being processed to produce actinium-225.

9. The method of recovering elements recited in claim 1, wherein one of the at least two elements comprises lithium.

10. The method of recovering elements recited in claim 1, wherein maximizing the value comprises maximizing value of a yield of the at least two elements combined.

11. The method of recovering elements recited in claim 1, wherein minimizing the cost of recovering the at least two elements comprises minimizing capital investment needed to recover the at least two elements.

12. The method of recovering elements recited in claim 1, wherein minimizing the cost of recovering the at least two elements comprises using a renewable energy source.

13. (canceled)

14. The method of recovering elements recited in claim 1, wherein maximizing the value includes maximizing a non-monetary benefit.

15. The method of recovering elements recited in claim 14, wherein the non-monetary benefit comprises reducing emission of greenhouse gasses.

16. The method of recovering elements recited in claim 1, wherein the designing of the process is performed by a machine learning method, the machine learning method comprising performing machine learning on a set of processes optimized for recovery of a single element.

17. A method of recovering radium and lithium from an aqueous stream, the method comprising:
filtering the aqueous stream to produce a permeate containing lithium and a retentate containing radium;
processing the permeate to recover the lithium; and
processing the retentate to recover the radium.

18. The method of recovering radium and lithium recited in claim 17, wherein the method is optimized to minimize a cost of recovering the radium and lithium and to maximize a value of recovering the radium and the lithium.

19. The method of recovering radium and lithium recited in claim 18, wherein maximizing the value comprises maximizing value of a yield of the radium and lithium combined.

20-28. (canceled)

29. The method of recovering radium and lithium recited in claim 17, wherein the radium comprises radium-226, the radium-226 being processed to produce actinium-225.

30. The method of recovering radium and lithium recited in claim 17, wherein the radium is processed to produce actinium.

31. The method of recovering radium and lithium recited in claim 17, comprising adjusting a pH level of the aqueous stream prior to recovering the radium and the lithium.

32. A computer-implemented method of designing a process to recover elements from an aqueous stream, the computer-implemented method comprising:
designing a process to recover at least two elements from the aqueous product stream, the at least two elements having different commercial values; and
optimizing the process to minimize a cost of recovering the at least two elements and to maximize a value of recovering the at least two elements.

33. A non-transitory, computer-readable storage medium comprising program instructions that are executable by a processor to cause the processor to:
design a process to recover at least two elements from the aqueous product stream, the at least two elements having different commercial values; and
optimize the process to minimize a cost of recovering the at least two elements and to maximize a value of recovering the at least two elements.
